(19) United States
(12) Patent Application Publication
(10) Pub. No.: US 2026/0325890 A1
(43) Pub. Date: Oct. 22, 2026

(54) PNEUMATIC DEVICE FOR AUTOMATIC FIRE BLANKET DEPLOYMENT APPARATUS IN ELECTRIC VEHICLE LITHIUM BATTERY FIRES

(71) Applicant: Taiwan Intelligent Robotics Company, Ltd., Taipei City (TW)

(72) Inventors: KUO-TSUNG HUANG, Taipei City (TW); YEN-CHU LAI, Taipei City (TW); SHIN-BIN KO, Taipei City (TW); YEN-HUNG LAI, Taipei City (TW)

(21) Appl. No.: 19/644,627

(22) Filed: Apr. 10, 2026

(30) Foreign Application Priority Data
Apr. 17, 2025 (TW) 114114570

(51) Int. Cl. A62C 2/24; A62C 2/10; A62C 3/07

(52) U.S. Cl. CPC A62C 2/248; A62C 2/10; A62C 3/07

(57) ABSTRACT

A pneumatic device for an automatic fire blanket deployment apparatus in electric vehicle lithium battery fires includes an air pressure supply unit and a pneumatic unit. The air pressure supply unit supplies high-pressure air to the pneumatic unit, and the pneumatic unit ejects a fire blanket by means of the high-pressure air, so that the fire blanket can cover a large-area fire source.

### REFERENCE TO RELATED APPLICATIONS

The present application is based on, and claims priority from, Taiwan application number 114114570, filed Apr. 17, 2025, the disclosure of which is hereby incorporated by reference herein in its entirety.

### BACKGROUND OF THE INVENTION

### Field of the Invention

The present invention relates to a pneumatic device of an automatic fire blanket covering apparatus in electric vehicle lithium battery fires, in particular to a pneumatic device capable of ejecting a fire blanket to cover large-area fire sources.

### Description of the Prior Art

A fire blanket, also known as a fire extinguishing blanket, is used for covering burning objects to cut off oxygen supply and extinguish flames.

Conventional fire blankets are manually deployed or manually cast to cover fire sources; however, such manual deployment or casting methods are only applicable to small-area fire sources. If the fire source covers a large area, such as the size of a vehicle, the aforesaid manual deploying or casting methods fail to allow the fire blanket to cover the fire source effectively.

To sum up, there is currently no device that enables a fire blanket to cover large-area fire sources. Developing a device capable of deploying a fire blanket to cover large-area fire sources has become an urgent improvement and innovation demand in the industry.

### SUMMARY OF THE INVENTION

In view of the above drawbacks of the prior art, improvements and innovations are desired. After numerous researches and experiments, the pneumatic device for an automatic fire blanket deployment apparatus in electric vehicle lithium battery fires of the present invention has been successfully developed.

The present invention provides a pneumatic device for an automatic fire blanket deployment apparatus in electric vehicle lithium battery fires, the pneumatic device including an air pressure supply unit and a pneumatic unit, wherein the air pressure supply unit includes an air pressure storage means and a pressure release means, and the pressure release means is coupled to the air pressure storage means; the pneumatic unit includes an air cylinder and a piston; the air cylinder is provided with an air cylinder opening at one end; an air chamber is formed inside the air cylinder; an air hole is provided at one end of the air chamber and located at the other end of the air cylinder; the air hole is coupled to the air pressure supply unit; the air chamber is provided with an air outlet at one end facing the air cylinder opening; the piston is arranged in the air chamber and provided with a head at one end, and the head is arranged at the air outlet.

The air pressure storage means is configured as an air tank capable of storing high-pressure air; the pressure release means includes an air pipe and a valve, the valve is arranged on the air pipe, and the air pipe is coupled to the air hole.

The valve is configured as an electromagnetic valve.

The pressure release means further includes a driving unit; the driving unit is provided with a gear set and a motor, the motor is coupled to the gear set, and the gear set is coupled to the valve.

The pressure release means further includes a driving unit; the driving unit is provided with a screw rod and a motor, the motor is coupled to the screw rod, and the screw rod is coupled to the valve.

The pneumatic unit further includes at least one actuator and a pneumatic elastic element; at least one accommodating cavity is provided at one end of the air chamber adjacent to the air outlet; the actuator is arranged in the accommodating chamber and provided with a latch and an elastic body, one end of the elastic body abuts against the latch, and the other end of the elastic body abuts against a bottom end of the accommodating chamber or a housing of the actuator; the piston is provided with a head at one end, the head is located at the air outlet, a clamping groove is provided on a peripheral side of the head, and one end of the latch abuts against a side wall of the head; the pneumatic elastic element has one end fixed to an inner wall of the air chamber and the other end fixed to the piston.

The pneumatic unit further includes at least one actuator and an pneumatic elastic element; the air chamber is internally provided with a partition chamber, and the partition chamber is provided with a partition chamber opening and at least one accommodating chamber at an end facing the air outlet; the actuator is arranged in the accommodating chamber and provided with a latch and an elastic body, one end of the elastic body abuts against the latch, and the other end of the elastic body abuts against the bottom end of the accommodating chamber or a housing of the actuator; one end of the piston extends into the partition chamber; a first pushing portion, a clamping groove and a second pushing portion are provided at the other end of the piston; the clamping groove is located between the first pushing portion and the second pushing portion, the first pushing portion is arranged at the partition chamber opening, the second pushing portion is located inside the partition chamber, and one end of the latch abuts against a side wall of the second pushing portion; the pneumatic elastic element is arranged inside the partition chamber, one end of the pneumatic elastic element abuts against an inner wall of the partition chamber, and the other end of the pneumatic elastic element abuts against the second pushing portion.

The diameter of the second pushing portion is larger than that of the first pushing portion.

In the pneumatic device for an automatic fire blanket deployment apparatus in electric vehicle lithium battery fires according to the present invention, the air pressure storage means can store high-pressure air and supply the high-pressure air to the pneumatic unit, so that the pneumatic unit can eject the fire blanket by means of the high-pressure air, thereby enabling the fire blanket to cover a large-area fire source.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a partial exploded perspective view of the pneumatic device for an automatic fire blanket deployment apparatus in electric vehicle lithium battery fires according to the present invention, mounted on a fire blanket cassette.

FIG. 2 is a perspective view of the pneumatic device for an automatic fire blanket deployment apparatus in electric vehicle lithium battery fires according to a first embodiment of the present invention.

FIG. 3 is a cross-sectional view of the pneumatic device for an automatic fire blanket deployment apparatus in electric vehicle lithium battery fires according to the first embodiment of the present invention.

FIG. 4 is a partial cross-sectional view of the pneumatic device for an automatic fire blanket deployment apparatus in electric vehicle lithium battery fires according to the first embodiment of the present invention.

FIG. 5 is a partial perspective view of the pneumatic device for an automatic fire blanket deployment apparatus in electric vehicle lithium battery fires according to a second embodiment of the present invention.

FIG. 6 is a cross-sectional view of the pneumatic device for an automatic fire blanket deployment apparatus in electric vehicle lithium battery fires according to the second embodiment of the present invention.

FIG. 7 is a partial cross-sectional view of the pneumatic device for an automatic fire blanket deployment apparatus in electric vehicle lithium battery fires according to the second embodiment of the present invention.

### DETAILED DESCRIPTION OF THE INVENTION

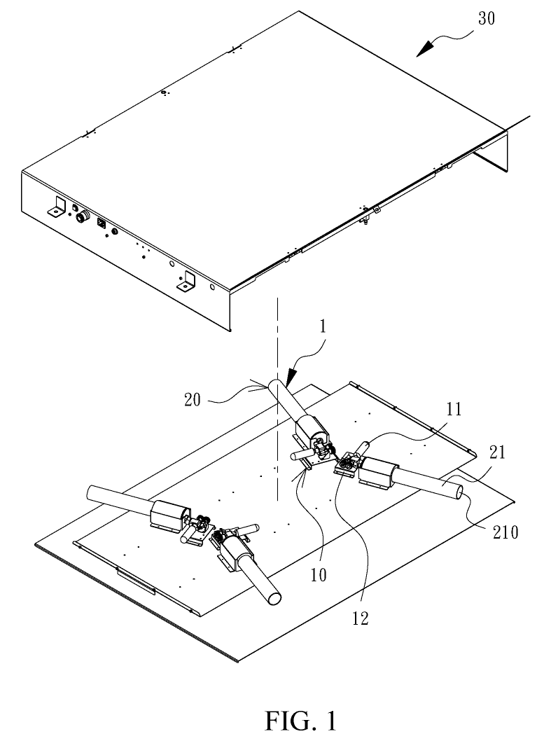

Referring to FIG. 1, it shows a partial exploded perspective view of the pneumatic device for an automatic fire blanket deployment apparatus in electric vehicle lithium battery fires according to the present invention, mounted on a fire blanket cassette. As shown in the figure, the pneumatic device 1 for an automatic fire blanket deployment apparatus in electric vehicle lithium battery fires according to a first embodiment of the present invention includes an air pressure supply unit 10 and a pneumatic unit 20. A plurality of said pneumatic devices for an automatic fire blanket deployment apparatus in electric vehicle lithium battery fires according to the present invention are disposed at four corners inside a fire blanket cassette 30.

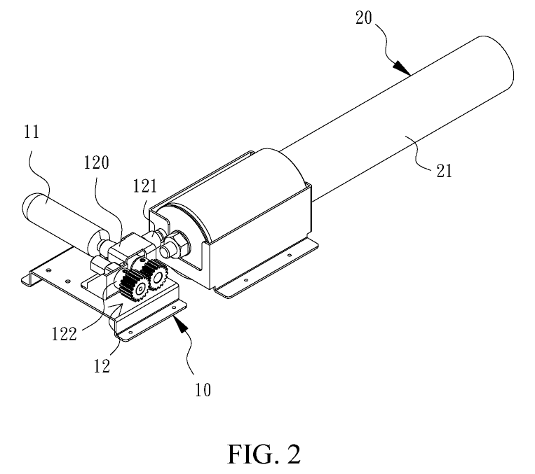

Referring to FIG. 2, it shows a perspective view of the pneumatic device for an automatic fire blanket deployment apparatus in electric vehicle lithium battery fires according to the first embodiment of the present invention. As shown in the figure, the air pressure supply unit 10 includes an air pressure storage means 11 and a pressure release means 12; the air pressure storage means 11 is configured as an air tank capable of storing high-pressure air; the pressure release means 12 is coupled to the air pressure storage means 11 and includes a valve 120, an air pipe 121 and a driving unit 122; the valve 120 is arranged on the air pressure storage means 11 and coupled to the air pipe 121.

In this embodiment, the driving unit 122 is provided with a gear set and a motor; the motor is coupled to the gear set, and the gear set is coupled to the valve 120. The motor drives the gear set to control the opening or closing of the valve 120.

In another embodiment, the driving unit 122 is provided with a screw rod and a motor; the motor is coupled to the screw rod, and the screw rod is coupled to the valve 120. The motor drives the screw rod to control the opening or closing of the valve 120.

In still another embodiment, in a case where the valve 120 is configured as an electromagnetic valve, the driving unit 122 may not be provided.

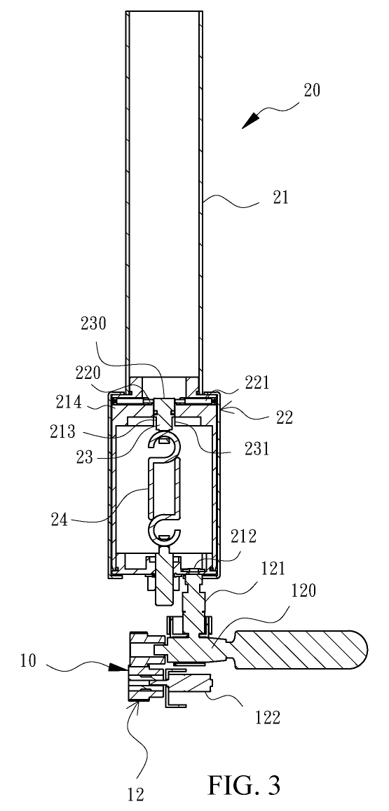

Referring to FIG. 3, it shows a cross-sectional view of the pneumatic device for an automatic fire blanket deployment apparatus in electric vehicle lithium battery fires according to the first embodiment of the present invention. As shown in the figure, the pneumatic unit 20 includes an air cylinder 21, at least one actuator 22, a piston 23 and a pneumatic elastic element 24.

The air cylinder 21 is provided with an air cylinder opening 210 at one end; an air chamber 211 is formed inside the air cylinder 21; an air hole 212 is provided at one end of the air chamber 211 and located at the other end of the air cylinder 21; the air hole 212 is coupled to the air pipe 121; an air outlet 213 and at least one accommodating chamber 214 are provided at the other end of the air chamber 211 adjacent to the middle end of the air cylinder 21.

One corner of a fire blanket (not shown) placed inside the fire blanket cassette 30 is sleeved on the air cylinder opening 210.

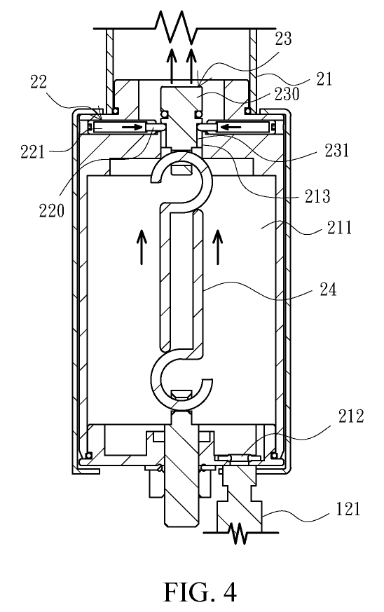

Referring to FIG. 4, it shows a partial cross-sectional view of the pneumatic device for an automatic fire blanket deployment apparatus in electric vehicle lithium battery fires according to the first embodiment of the present invention. As shown in the figure, the actuator 22 is arranged in the accommodating chamber 214 and provided with a latch 220 and an elastic body 221; one end of the elastic body 221 abuts against the latch 220, and the other end of the elastic body 221 abuts against the bottom end of the accommodating chamber 214 or a housing of the actuator 22.

The piston 23 is provided with a head 230 at one end, the head 230 is located at the air outlet 213, and a clamping groove 231 is provided on a peripheral side of the head 230. The pneumatic elastic element 24 has one end fixed to an inner wall of the air chamber and the other end fixed to the piston 23. The pneumatic elastic element 24 is configured to keep the head 230 of the piston 23 at the air outlet 213. One end of the latch 220 abuts against a side wall of the head 230.

Referring to FIGS. 3-4 again, when an electric vehicle is on fire, the air pressure supply unit 10 receives a release signal, and the motor drives the gear set to open the valve 120, or the motor drives the screw rod to open the valve 120.

After the valve 120 is opened, the high-pressure air inside the air pressure storage means 11 enters the air chamber 211 via the air pipe 121 and the air hole 212. When the air pressure inside the air chamber 211 exceeds a preset pressure value, the high-pressure air pushes the head 230 to move in a direction away from the air outlet 213, and the moving piston 23 stretches the pneumatic elastic element 24.

Then, when the clamping groove 231 moves to the position of the actuator 22, the elastic body 221 pushes the latch 220 toward the clamping groove 231, and the latch 220 extends into the clamping groove 231 to limit the movement of the head 230 and maintain the air outlet 213 in an open state.

Then, the high-pressure air is ejected from the air outlet 213, and further continuously ejected through the air cylinder opening 210 to drive the fire blanket, so that the fire blanket can cover a fire source, such as a burning electric vehicle. After use of the pneumatic device for an automatic fire blanket deployment apparatus in electric vehicle lithium battery fires according to the present invention, the air pressure storage means 11 can store high-pressure air again, and the latch 220 of the actuator 22 can return, so that the piston 23 is pulled back by the pneumatic elastic element 24, and the head 230 closes the air outlet 213 again.

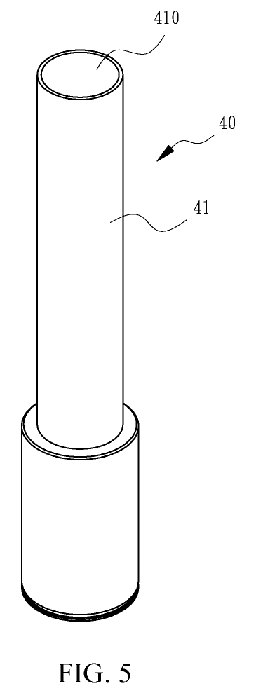

Referring to FIG. 5, it shows a partial perspective view of the pneumatic device for an automatic fire blanket deployment apparatus in electric vehicle lithium battery fires according to a second embodiment of the present invention. As shown in the figure, the pneumatic device for an automatic fire blanket deployment apparatus in electric vehicle lithium battery fires according to the second embodiment of the present invention includes an air pressure supply unit (not shown) and a pneumatic unit 40. In this embodiment, the air pressure supply unit is identical to that of the foregoing embodiment. It is hereby expressly stated that the air pressure supply unit will not be described in detail herein.

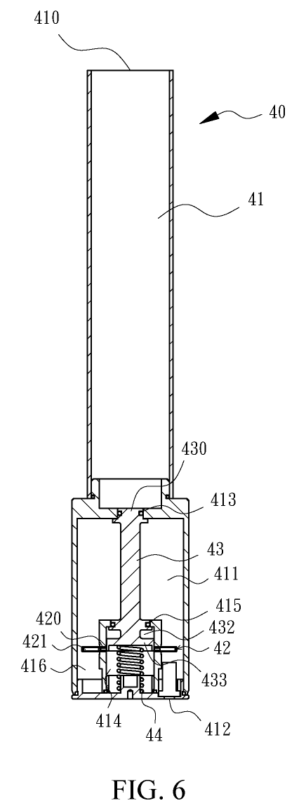

Referring to FIG. 6, it shows a cross-sectional view of the pneumatic device for an automatic fire blanket deployment apparatus in electric vehicle lithium battery fires according to the second embodiment of the present invention. As shown in the figure, the pneumatic unit 40 includes an air cylinder 41, at least one actuator 42, a piston 43 and a pneumatic elastic element 44.

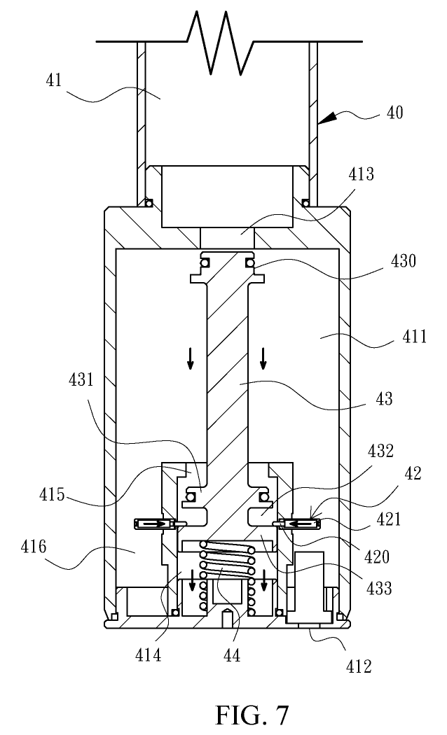

Referring to FIG. 7, it shows a partial cross-sectional view of the pneumatic device for an automatic fire blanket deployment apparatus in electric vehicle lithium battery fires according to the second embodiment of the present invention. As shown in the figure, the air cylinder 41 is provided with an air cylinder opening 410 at one end; an air chamber 411 is formed inside the air cylinder 41; an air hole 412 is provided at one end of the air chamber 411 and located at the other end of the air cylinder 41; the air hole 412 is coupled to the air pipe of the air pressure supply unit; an air outlet 413 is provided at the other end of the air chamber 411 adjacent to the middle end of the air cylinder 41; the air chamber 411 is internally provided with a partition chamber 414, and the partition chamber 414 is provided with a partition chamber opening 415 and at least one accommodating chamber 416 at an end facing the air outlet 413.

The actuator 42 is arranged in the accommodating chamber 416 and provided with a latch 420 and an elastic body 421; one end of the elastic body 421 abuts against the latch 420, and the other end of the elastic body 421 abuts against the bottom end of the accommodating chamber 416 or a housing of the actuator 42.

The piston 43 is arranged inside the air chamber 411. One end of the piston 43 extends into the partition chamber 414. The piston 43 is provided with a head 430 at one end, and the head 430 is located at the air outlet 413. A first pushing portion 431, a clamping groove 432 and a second pushing portion 433 are provided at the other end of the piston 43. The clamping groove 432 is located between the first pushing portion 431 and the second pushing portion 433. The first pushing portion 431 is arranged at the partition chamber opening 415, the second pushing portion 433 is located inside the partition chamber 414, and the diameter of the second pushing portion 433 is larger than that of the first pushing portion 431. One end of the latch 420 abuts against a side wall of the second pushing portion 433.

The pneumatic elastic element 44 is arranged inside the partition chamber 414, one end of the pneumatic elastic element 44 abuts against an inner wall of the partition chamber 414, and the other end of the pneumatic elastic element 44 abuts against the second pushing portion 433.

Referring to FIGS. 6-7, after the air pressure supply unit receives a release signal, high-pressure air enters the air chamber 411 via the air hole 412. When the air pressure inside the air chamber 411 exceeds a preset pressure value, the high-pressure air pushes the first pushing portion 431 to open the partition chamber opening 415. After the partition chamber opening 415 is opened, the high-pressure air enters the partition chamber 414 and pushes the second pushing portion 433, so that the piston 43 moves toward the inside of the partition chamber 414 and compresses the pneumatic elastic element 44.

Then, when the clamping groove 432 moves to the position of the actuator 42, the elastic body 421 pushes the latch 420 toward the clamping groove 432, and the latch 420 extends into the clamping groove 432 to limit the movement of the head 430 and maintain the air outlet 413 in an open state.

Then, the high-pressure air is ejected from the air outlet 413, and further continuously ejected through the air cylinder opening 410 to drive the fire blanket, so that the fire blanket can cover a fire source, such as a burning electric vehicle.

In summary, in the pneumatic device for an automatic fire blanket deployment apparatus in electric vehicle lithium battery fires according to the present invention, the air pressure storage means can store high-pressure air. The pressure release means can open the valve in response to a release signal, allowing the high-pressure air to enter the air cylinder. When the air pressure inside the air cylinder reaches a preset pressure value, the fire blanket is ejected, so that the fire blanket can cover a large-area fire source.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pneumatic device for an automatic fire blanket deployment apparatus in electric vehicle lithium battery fires, the pneumatic device comprising:
an air pressure supply unit comprising an air pressure storage means and a pressure release means, the pressure release means being coupled to the air pressure storage means, and
a pneumatic unit comprising an air cylinder and a piston, wherein the air cylinder is provided with an air cylinder opening at one end; an air chamber is formed inside the air cylinder; an air hole is provided at one end of the air chamber and located at the other end of the air cylinder; the air hole is coupled to the air pressure supply unit; the air chamber is provided with an air outlet at one end facing the air cylinder opening; the piston is arranged in the air chamber and provided with a head at one end, and the head is arranged at the air outlet.

2. The pneumatic device for an automatic fire blanket deployment apparatus in electric vehicle lithium battery fires according to claim 1, wherein the air pressure storage means is configured as an air tank capable of storing high-pressure air; the pressure release means comprises an air pipe and a valve, the valve is arranged on the air pipe, and the air pipe is coupled to the air hole.

3. The pneumatic device for an automatic fire blanket deployment apparatus in electric vehicle lithium battery fires according to claim 2, wherein the valve is configured as an electromagnetic valve.

4. The pneumatic device for an automatic fire blanket deployment apparatus in electric vehicle lithium battery fires according to claim 2, wherein the pressure release means further comprises a driving unit; the driving unit is provided with a gear set and a motor, the motor is coupled to the gear set, and the gear set is coupled to the valve.

5. The pneumatic device for an automatic fire blanket deployment apparatus in electric vehicle lithium battery fires according to claim 2, wherein the pressure release means further comprises a driving unit; the driving unit is provided with a screw rod and a motor, the motor is coupled to the screw rod, and the screw rod is coupled to the valve.

6. The pneumatic device for an automatic fire blanket deployment apparatus in electric vehicle lithium battery fires according to claim 1, wherein the pneumatic unit further comprises at least one actuator and a pneumatic elastic element; at least one accommodating cavity is provided at one end of the air chamber adjacent to the air outlet; the actuator is arranged in the accommodating chamber and provided with a latch and an elastic body, one end of the elastic body abuts against the latch, and the other end of the elastic body abuts against a bottom end of the accommodating chamber or a housing of the actuator; the piston is provided with a head at one end, the head is located at the air outlet, a clamping groove is provided on a peripheral side of the head, and one end of the latch abuts against a side wall of the head; the pneumatic elastic element has one end fixed to an inner wall of the air chamber and the other end fixed to the piston.

7. The pneumatic device for an automatic fire blanket deployment apparatus in electric vehicle lithium battery fires according to claim 1, wherein the pneumatic unit further comprises at least one actuator and an pneumatic elastic element; the air chamber is internally provided with a partition chamber, and the partition chamber is provided with a partition chamber opening and at least one accommodating chamber at an end facing the air outlet; the actuator is arranged in the accommodating chamber and provided with a latch and an elastic body, one end of the elastic body abuts against the latch, and the other end of the elastic body abuts against a bottom end of the accommodating chamber or a housing of the actuator; one end of the piston extends into the partition chamber; a first pushing portion, a clamping groove and a second pushing portion are provided at the other end of the piston; the clamping groove is located between the first pushing portion and the second pushing portion, the first pushing portion is arranged at the partition chamber opening, the second pushing portion is located inside the partition chamber, and one end of the latch abuts against a side wall of the second pushing portion; the pneumatic elastic element is arranged inside the partition chamber, one end of the pneumatic elastic element abuts against an inner wall of the partition chamber, and the other end of the pneumatic elastic element abuts against the second pushing portion.

8. The pneumatic device for an automatic fire blanket deployment apparatus in electric vehicle lithium battery fires according to claim 7, wherein the diameter of the second pushing portion is larger than that of the first pushing portion.
